(19) United States
(12) Patent Application Publication
(10) Pub. No.: US 2015/0047524 A1
(43) Pub. Date: Feb. 19, 2015

(54) METHOD FOR CREATING DESIGNS AND RAISED PATTERNS ON THE FOLDS, RECESSED PORTIONS, AND EDGE SURFACES OF OBJECTS CONSISTING OF SHEETS

(71) Applicant: Cristian Todie, Paris (FR)

(72) Inventor: Cristian Todie, Paris (FR)

(21) Appl. No.: 14/379,800

(22) PCT Filed: Feb. 19, 2013
(86) PCT No.: PCT/FR2013/000045

§ 371 Date: Aug. 20, 2014

(30) Foreign Application Priority Data
Feb. 21, 2012 (FR) 1200500

(51) Int. Cl. B41F 17/02

(52) U.S. Cl. CPC B41F 17/02
USPC 101/483

(57) ABSTRACT

The present invention relates to the bulk manufacture of objects, materials, or products from sheets or fabrics, which are either folded or to be folded, with designs, images, text, and raised patterns that are reconstituted strip by strip at the edge of the folds thereof, in the recessed portions, and in the edge surfaces. The novelty of the present invention is that a process for repeating designs and shapes, which are shifted relative to one another, on at least one sheet and from one sheet to the other, by reproducing, cutting, or stamping, is merged with folding operations necessitated by the design or suitable for the technical process of the machines in a predetermined manufacturing procedure. The method is mainly useful in book publishing and stationery. Said method can also lend itself to the innovation of novel shapes for books and notebooks produced in bulk, e.g. having a cylindrical or triangular-prism shape or bas-reliefs on the edge surface thereof, and to objects, games, toys, jewelry, as well as to fashion accessories, decorative objects, promotional stands, packaging, furniture, and to various novel textile materials and panels made of various materials.

The present invention relates to the manufacturing of objects, materials or products in volume from sheets or fabrics, folded or intended to be folded, with designs, images, texts and raised patterns, reconstituted strip by strip, at the edge of their folds, in the recessed parts and in the edge surfaces.

The method applies mainly to the publishing of books and to stationery, for example: brochures, notebooks, sketchbooks, notepads, diaries and catalogs. It may also lend itself to the innovation of novel forms of books and notebooks in bulk, for example cylindrical (FIG. 2f) or triangular prism (FIG. 6d) or with bas-reliefs on the edge surface (FIG. 11g) and also to objects, games, toys, jewelry as well as to fashion accessories, decorative objects, promotional stands, packaging, furniture, and to various novel textile materials and panels made of various materials.

Currently, decorative objects made of cellular paper, also called honeycomb paper, for example decorative garlands or other objects (Asian) which are made of joined colored papers just like objects deriving from the French patent of invention Nr86383737. In the manufacturing of paper objects, the folding operations are these days limited quite simply to the joining of sheets for technical or practical reasons.

The novelty of the present invention lies in the merging of a process of repeating designs and shapes, which are shifted relative to one another, on at least one sheet and from one sheet to another, by reproduction, cutting or stamping, with folding operations dictated by the design or suited to the technical process of the machines in a determined manufacturing procedure.

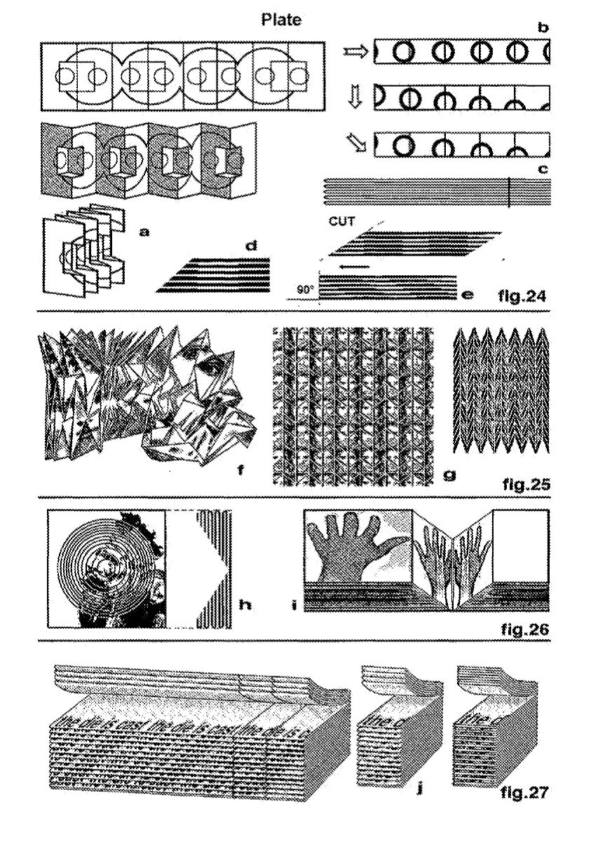

The shifting of the patterns can be produced, for example, in a horizontal or vertical or diagonal (FIG. 24b) direction depending on whether the designs are to be shown on the folds and in the lateral edge surfaces or on the bottom and top edge surfaces. The repetition of the patterns can be produced in a single direction (FIG. 1) for simple folding operations (FIG. 3), or in several directions (FIG. 25g) for complex folding operations (FIG. 25).

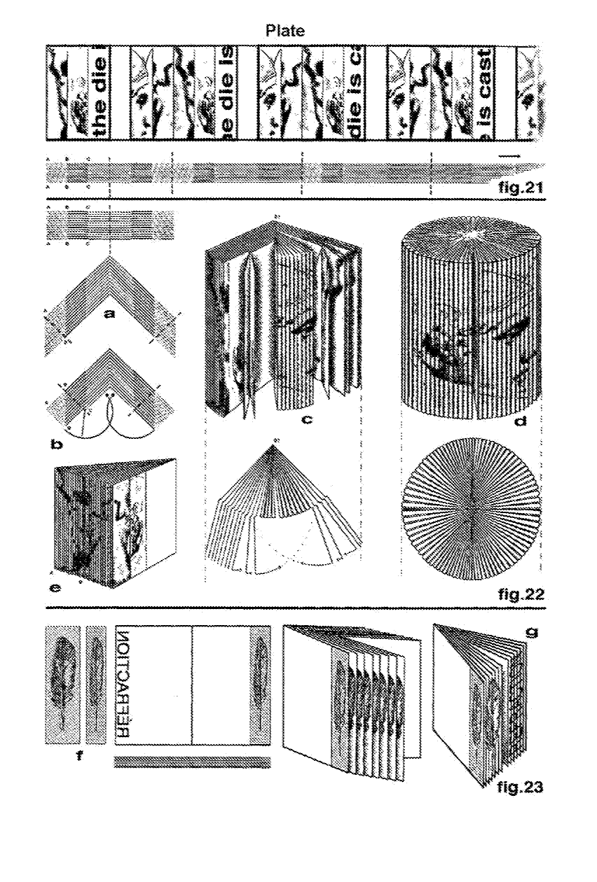

The designs can be made up of one or more elements, for example texts, images and cutout shapes, and can be reproduced identically or its components can change relative to one another, for example a text is shifted from one design to another relative to the artwork which remains identical (FIG. 21), or an image which is reproduced identically is accompanied by cutout shapes which change, in a coherent relationship, such as, for example, topometric lines of a geometrical volume (FIG. 9a) or figurative volume (FIG. 11e). For folds consisting for example of mixed harmonica type, the designs can comprise a number of elements each intended to appear on different folds (FIG. 24a). Depending on the design of the object, certain parts of the designs will be intended to appear, in the context of the same product, for example one in the edge surface of the sheets (FIG. 22e) and another at the folds (FIG. 22d). In the preparation of the designs, depending on the parameters of the procedure decided upon, certain images can be distorted or deconstructed. The repetition of the patterns can also be replaced, for example in the case of zig-zag folds, by the anamorphosis of the design on the length of the sheet. The designs used can also be related to one another, such as, for example, the sequences of a deconstructed motion (film, animation). For the wound fold (FIG. 14), a particular topometry may be used which consists in sampling the spiral dimensioning of a raised pattern followed by the corresponding linear cutting, on the edge of a sheet, which, once folded (wound), restores the original raised pattern.

The cutting form can be associated with a scoring operation at the point of the fold (FIGS. 9 and 11e) or on the edge of the sheets (FIG. 10b, 11d), repetitively with the same form (FIG. 10c) or with different (e.g. topometric) and progressive forms on each sheet (FIG. 11d) or from one sheet to another (FIG. 11f). At the edge of the objects, produced from a single sheet or from a block of sheets, the volume from which the topometric samplings originate is restored to the appearance of a geometrical (FIG. 9), figurative (FIG. 11g) or any other bas-relief.

The reproductions can be performed recto or recto-verso, by any methods, for example offset, typo screen printing, decalcomania, embossing, photo reproduction, digital, hologram, lenticular.

Reducing the surface areas occupied by the design in the strips corresponding to the folding or guillotining point frees up the interior of the sheets to be able to accommodate the elements necessary to the design of the object for which the application is intended (FIGS. 6 and 7), or quite simply to the planned use, for example writing (e.g. notebook).

The shifting of the designs from one sheet to another can be designed at the page formatting stage or can be performed by offsetting the sheets at the time of reproduction at the jogging level in the conventional printing machines or obtained by an operation of folding of the volume of the sheets (FIG. 22a), the degree of offset being related to the thickness of the paper, or also by an operation of cutting of the blocks of sheets slantwise and a rearrangement of the block of sheets at an angle of 90° (FIG. 24e).

The folding operation or operations (for example crossed, parallel, mixed, zig-zag, wound folds) (FIG. 3g) can be applied to a volume of sheets at the same time or sheet by sheet, in the same direction, harmonica-fashion or random, performed in folding machines or manually possibly accompanied by scoring operations. The scorings can be of various sizes and forms, double or multiple, in order to give more thickness to the edge surface, parallel to one another or not according to the designs of the objects.

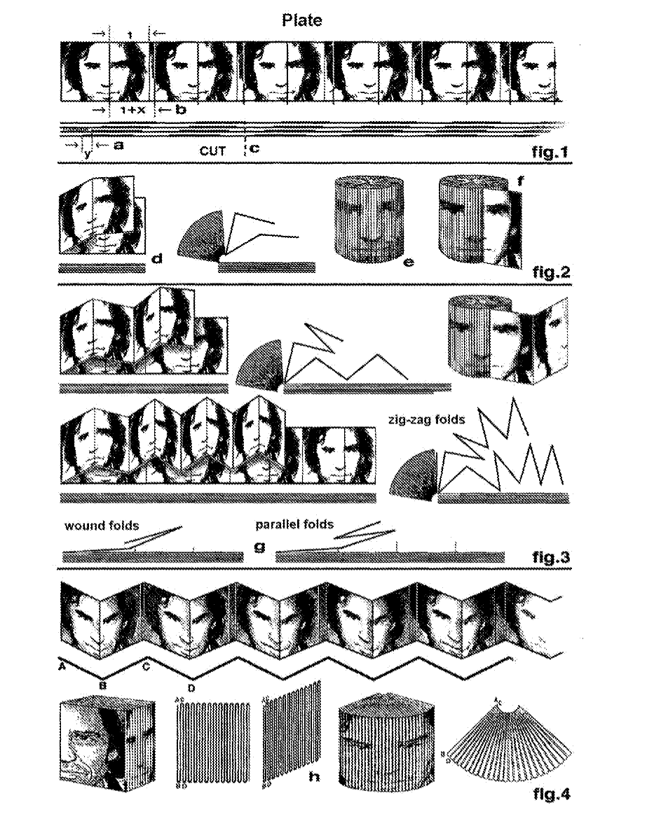

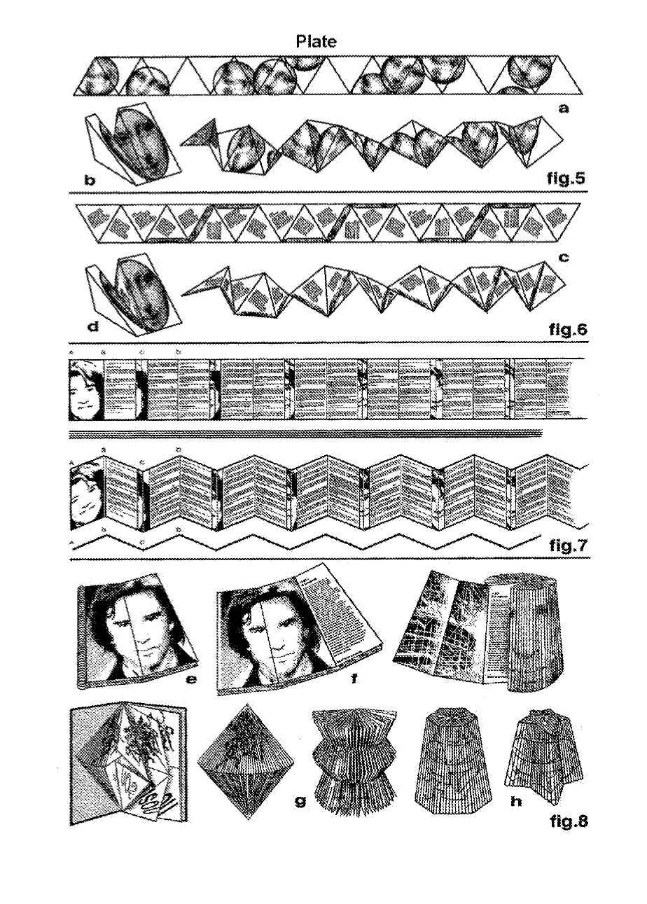

In the manufacturing of objects from a single sheet comprising a scoring operation with parallel lines and a zig-zag folding operation, the original design is reconstituted in successive strips on the lateral surfaces of the object (FIG. 4). In the manufacturing of objects from a single sheet comprising reproduction, scoring and folding operations, relative to successive lines that are not parallel, for example at alternating angles of 60° (FIG. 5a), the result is, for example, triangular books with designs reconstituted on the three lateral sides (FIG. 5b) and which can be opened in three directions.

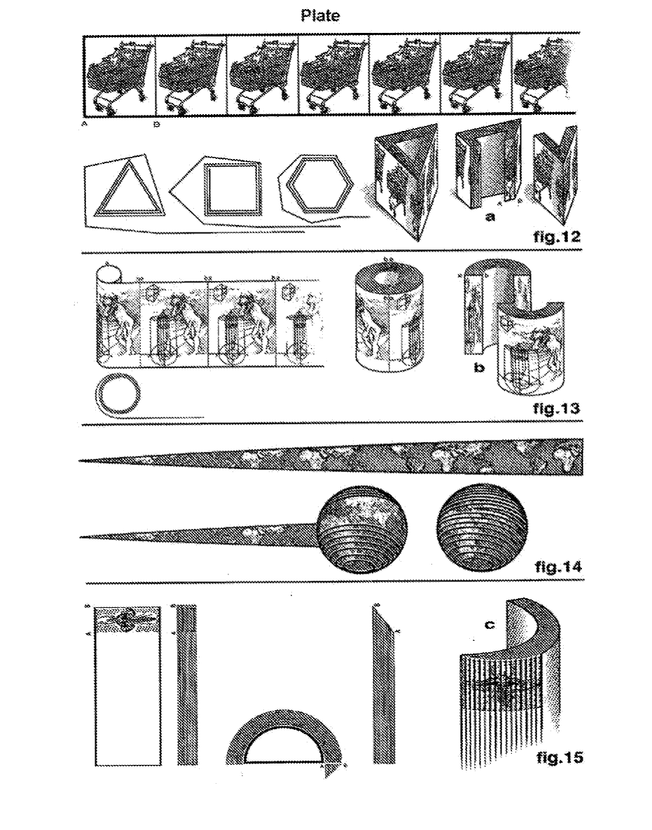

The sheet folding operation can be performed at angles other than 180° and with differences between the folds increasingly smaller to a zero value, for example 120°, 90° and 60° (FIG. 12), and in each case, the fold is produced in the same direction, with the space between the folds and the curvature of the fold increased relative to the preceding ones with values proportional to the thickness of the sheets. This results in volumes in the form of triangular, square, hexagonal, octogonal, etc. prisms, to a cylindrical form (FIG. 13). In these volumes, each design is offset relative to the design below by a difference proportional to the thickness of the paper and its volumes, once cut, show, in the edge surfaces of the sheets, the reconstituted designs (FIGS. 12a and 13b), or, in the case of a reduction of the width of the sheets by topometric precutting, the design is reconstituted on the edge of the volume (FIG. 14). The places of the folding can be determined by a scoring, a perforation, indicated by markers or quite simply determined by the dimensions or the forms of the sheet or of the sheets to be folded.

In this method, it is possible to use sheets of various materials and of various thicknesses, laminated or woven, rigid or flexible, opaque or transparent, for example paper, cardboard, plastic, metal or textile. The folding operations can be performed cold or hot.

The method also matches with French or Chinese assembly operations (FIG. 24c), for example spiral-bound, glued, stitched, stapled, and cutting operations, for example laser, hole-punching, guillotining, before or after the folding operations, applied to the block of sheets or sheet by sheet. The cutting operations can be performed with one and the same form or with different forms.

The novel method can be adapted to multiple industrial manufacturing procedures, with edge surfaces of designs placed at the levels provided for the folding or cutting by an imposition operation in the folios, a method that consists in distributing the pages and in placing them correctly on the form; in order, ultimately, once the sheet has been folded and the notebooks placed together, for the design to be reconstituted on the folds, the cellular parts or the edge surfaces of objects. It is also possible to adapt the method to the manufacturing procedure, for example notebooks, by the positioning of the design, possibly compressed (FIG. 23f), at the place provided for the guillotining after the operation of folding of the blocks of sheets, in order for the designs to be reconstituted by successive strips in the edge surface of the notebooks (FIG. 23g).

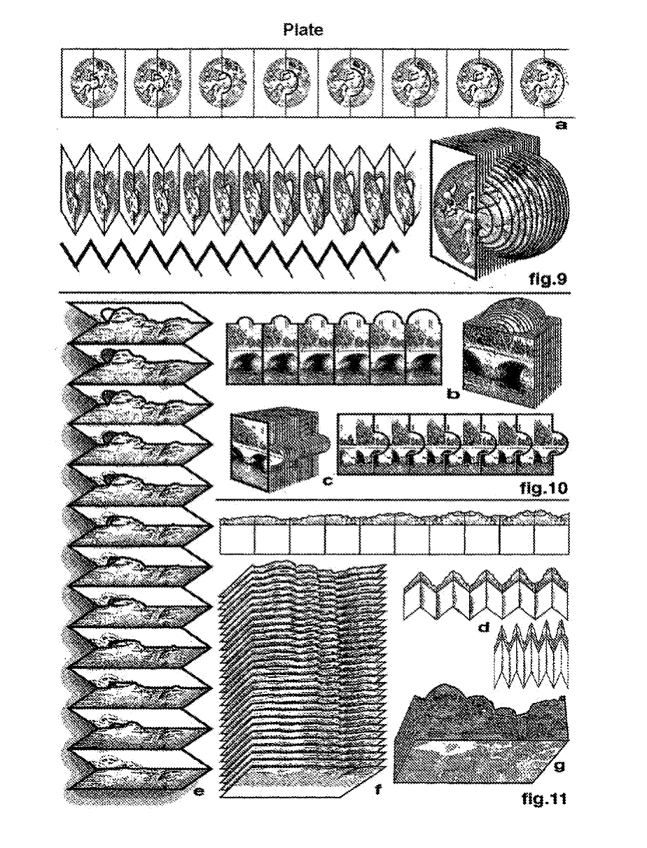

The volume books deriving from this method can be rectangular, circular or just in circular arc form or equally in different forms for example (on a base that is) triangular, hexagonal, star-shaped (FIG. 8), and can be opened on one or more sides.

On opening any sheet of a circular book, in its first form (FIG. 2), deriving from this method, according to the direction of the offsets of the designs, it is possible to restore the part of the corresponding design in the continuity of the overall design (FIG. 2f). In the same context, the regular, simple or combined folding at any level of sheets, reveals the original design (FIG. 8g).

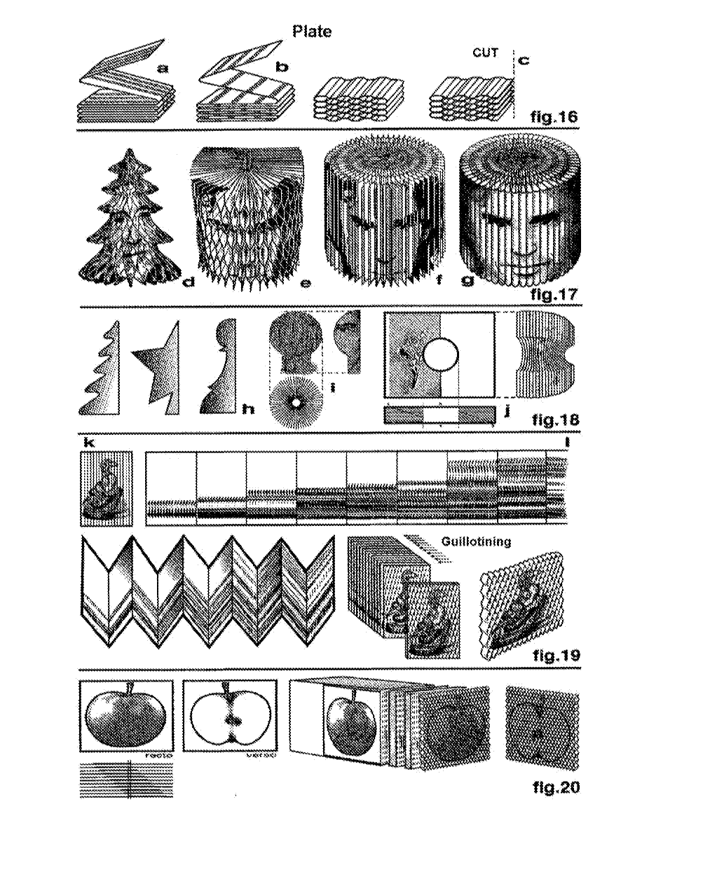

The sheets can be secured by gluing, so as to obtain cellular blocks of honeycomb type. The operation consists in depositing, before the folding, lines of glue offset relative to one another from one sheet to another or from one flap to the other of the same sheet. The lines of glue can be deposited parallel to the fold (FIG. 16b), making it possible to reconstitute the design on the pleats of the object (FIG. 17g) and, after an optional guillotining operation, also parallel to the fold (FIG. 16c), restore the reconstituted design in the longitudinal cells (FIG. 17f), or at right angles to the fold (FIG. 16a) in the case of production, for example, of cellular slices (FIGS. 19 and 20).

The patterns are shifted for example in a horizontal or vertical direction (FIG. 24b) depending on whether the aim is to have them revealed in the honeycomb-type cellular parts (FIGS. 17d and 17e) or on the folds (FIG. 17g). The cellular slices (FIG. 20) make it possible to read recto and verso prints from a different viewpoint.

The preparation of the designs is adapted to the design of the object, for example by series of strips (FIG. 19l) corresponding to slices of a cut image (FIG. 19k). The separations of blocks, or any other cutting-based finishing operation, can also be performed slantwise (FIG. 24d) in order to better reveal the images in the slices. The method makes it possible to produce animations generated by the offsetting of animated designs or texts by leafing through the pages (FIG. 27). The same object can have a number of folding possibilities allowing for transformations by form or by artwork. It is also possible to design objects in photographic paper corresponding to all these proposals and particularly in origami where the reproduction is produced after the folding by photographic methods.

It is possible to adapt the method to the computing world and create fixed or animated virtual images reflecting the manufacturing procedure through existing 3D software or by creating suitable new software.

This industrial method is based on the idea of a geometrical space with memory, with different parameters relative to the metric values of the objects and which, in printing, finds the ideal universe for its experimentation. The image reproduced on superposed sheets appears as projected (extrudes) and fixed in the mass of sheets.

Concerning this spatial volume, it can be imagined that each of these parallel planes stores all the volumetric and chromatic values of an object which passes through it and that the offsetting of these imprints from one plane to another contains a space-time value which reveals the direction of the motion.

In the will to return to the origin of the constructions of forms and of volumes from a point, from a line or from a plane, the mathematical nature with memory of this mass allows for experimental manipulations and, through spatial fractures, projects the original object into another space, that of a parallel reality.

The substance, that printing provides, once sliced or folded intelligently, reveals the original image and forms in volume refractions, reflections and anamorphoses and the objects deriving from this method make it possible to become accustomed to a novel mathematical vision.

1) A method for manufacturing objects in the form of sheets that are folded or intended to be folded comprising designs and raised patterns reconstituted strip by strip at the edge of their folds (FIG. 2e), characterized by an operation of reproducing designs, on the front or back, by printing and by cutting (FIG. 1 and 9a) which are repeated or which follow one another in at least one direction on one or more sheets, systematically shifted relative to one another from one sheet to another (FIG. 1a), accompanied by a series of scorings produced at regular intervals and progressively shifted relative to the designs (FIG. 1b), followed by a separation operation performed by the cutting of blocks of sheets (FIG. 1c) comprising one or more instances of the design (FIGS. 2 and 3), joined and followed by an operation of folding of each sheet.

2) The manufacturing method as claimed in the first claim, characterized by the use of a single sheet comprising an operation of scoring with parallel lines and a zig-zag folding operation. The original design is reconstituted in successive strips on the lateral surfaces of the object (FIG. 4).

3) The manufacturing method as claimed in claims 1 and 2, characterized by the performance of the reproduction, scoring and folding operations, relative to successive lines that are not parallel, for example at alternating angles of 60° (FIG. 5a). The result, for example, is a triangular book with designs reconstituted on the three lateral sides (FIGS. 5b and 5d) and which can be opened in three directions.

4) The manufacturing method as claimed in claims 1, 2 and 3, characterized by the repetition of designs widthwide and heightwise (FIG. 25g) with an operation of harmonica-like combined grooving and folding in two directions systematically offset relative to the designs (FIG. 25). The result is a sheet which contracts with patterns which are reconstituted on its pleats.

5) The manufacturing method as claimed in claims 1, 2, 3 and 4, characterized by a cutting operation associated with the reproduction operation at the point of the fold (scoring) (FIG. 9a) or on the edge of the sheets (FIGS. 10b and 11d), repetitively with the same form (FIG. 10c) or with different forms, for example progressive topometric levels on each sheet (FIGS. 9 and 11e) or from one sheet to another (FIG. 11f). On the edge of the objects produced, there appear, for example, geometrical bas-reliefs (FIGS. 9 and 10b) or figurative bas-reliefs (FIG. 11g).

6) The manufacturing method as claimed in claims 1, 2 and 3, characterized by an operation of folding of sheets at angles other than 180° and increasingly smaller distances between the folds to a zero value, for example 120°, 90° and 60° (FIG. 12), and in each case, the fold is produced in the same direction, with the space between the folds and the curvature of the fold increased relative to the preceding ones with values proportional to the thickness of the sheets. This results in volumes in the form of triangular, square, hexagonal, octagonal, etc. prisms, to a cylindrical form (FIG. 13). In these volumes, each design is offset relative to the design below by a difference proportional to the thickness of the paper and its volumes, once cut, once again show, in the edge surfaces of the sheets, the reconstituted designs (FIGS. 12a and 13b), or, in the case of a reduction of the width of the sheets by topometric precutting, the design is reconstituted on the edge of the volume (FIG. 14).

7) The manufacturing method as claimed in any one of the preceding claims, characterized by operating of securing the sheets by gluing, so as to obtain cellular blocks of honeycomb type. The operation consists in depositing, before the folding, lines of glue offset relative to one another from one sheet to another or from one flap to the other of the same sheet. The lines of glue can be deposited parallel to the fold (FIG. 16b), making it possible to reconstitute the design on the pleats of the object (FIG. 17g) and, after an optional guillotining operation, also parallel to the fold (FIG. 16c), restore the reconstituted design in the longitudinal cells (FIG. 17f), or at right angles to the fold (FIG. 16a) in the case of production, for example, of cellular slices (FIGS. 19 and 20).

8) The manufacturing method as claimed in the first claim, characterized by the zero offset of the designs from one sheet to another, an offset which will be obtained by an operation of folding of the blocks of sheets (FIG. 22a) followed by a second folding operation performed sheet by sheet which will make it possible to reconstitute, on the edges of pleats of a part of the design and, in the edge surface, after a guillotining operation, another part of the pattern (FIG. 22e).

9) The manufacturing method as claimed in claims 1, 2, 3 and 8, characterized by scoring-folding operations performed at distances and angles calculated in order to obtain, ultimately, volumes other than cylinders (FIGS. 8e and 8f) or rectangular, such as, for example, truncated hexagonal or star-shaped (FIG. 8h) or parallelepipedal (FIG. 4h) pyramids.

10) The manufacturing method as claimed in any one of the preceding claims, characterized by operations of cutting of the total or partial volume of the blocks of sheets, in any step of the process, for example by stamping (conventional or by the log), by laser cutting at right angles relative to the planes of the sheets (FIG. 18j) or oblique (FIG. 24d), an operation which allows parts of the design to be revealed in the edge surfaces (FIGS. 26h and 26i).

11) The manufacturing method as claimed in any one of the preceding claims, characterized by the reproduction only of the strips of designs corresponding to the folding and cutting points, in order to free up space for texts and images corresponding to the object, for example books, notebooks, catalogs and brochures with the same result concerning the reconstitution of the designs on the pleats and optionally on the edge surface (FIG. 6, 7).
